(19) United States
(12) Patent Application Publication
(10) Pub. No.: US 2024/0227065 A1
(43) Pub. Date: Jul. 11, 2024

(54) METHOD FOR MONITORING A LASER WELDING PROCESS, AND ASSOCIATED LASER WELDING SYSTEM

(71) Applicant: PRECITEC GMBH & CO. KG, Gaggenau (DE)

(72) Inventors: Tom Walde, Offenburg (DE); Rüdiger Moser, Malsch (DE); Stefan Birmanns, Rheinau (CH); Fabian Becker, Karlsbad (DE); Igor Shkarban, Rheinstetten (DE); Livia Barazzetti, Wettingen (CH); Maurizio Kempf, Völkersweile (DE)

(21) Appl. No.: 18/558,907

(22) PCT Filed: May 3, 2022
(86) PCT No.: PCT/EP2022/061848

§ 371 Date: Nov. 3, 2023

(30) Foreign Application Priority Data
May 3, 2021 (DE) 10 2021 111 349.0

(51) Int. Cl. B23K 26/03; B23K 26/21

(52) U.S. Cl. CPC B23K 26/03; B23K 26/21

(57) ABSTRACT

A method for monitoring a laser welding process includes the steps of: performing the laser welding process by irradiating a laser beam onto at least one work piece to form a weld joint, wherein the laser beam is guided along a processing path by a deflection device, detecting sensor data by at least two sensors during the laser welding process, and determining whether the weld joint has a defect based on the detected sensor data and at least one processing parameter of the laser welding process. An associated laser welding system is also provided.

### CROSS-REFERENCE TO RELATED APPLICATIONS

This application is the U.S. National Stage of PCT/EP2022/061848 filed on May 3, 2022, which claims priority to German Patent Application 102021111349.0 filed on May 3, 2021, the entire content of both are incorporated herein by reference in their entirety.

### FIELD OF THE INVENTION

The present invention relates to a method for monitoring a laser welding process, in particular for determining whether a weld joint formed by the laser welding process has a defect, and to a laser welding system arranged to perform the method.

### BACKGROUND OF THE INVENTION

In a laser welding system, also referred to as a laser welding equipment or equipment for short, the laser beam emitted from a laser beam source or one end of a laser guiding fibre is irradiated and focused onto the work pieces with the aid of beam guiding and focusing optics in order to weld work pieces. The laser welding system can comprise a laser welding head in which the beam guiding and focusing optics are integrated. The laser beam is moved along a so-called processing path over the surface of the work pieces, whereby a vapour capillary, also known as a keyhole, is formed in a region between the surface onto which the laser beam is irradiated and into a certain depth within a work piece. In the region of the vapour capillary, the material of the work piece heats up to such an extent by the irradiated laser power that it vaporises. The vapour capillary is surrounded by a melt pool in which the material is in a molten state. When the material cools down, a weld is created which forms the weld joint between the welded work pieces, wherein the welded work pieces can also be referred to as a (single) component.

To ensure the quality of the weld or the weld joint, it is necessary to monitor the laser welding process. This is because defects can occur in a weld which cannot be tolerated with regard to the properties of the component. If, for example, there is a gap between the welded work pieces, they may have to be rejected as rejects. In particular, if there is a gap without bridging, a mechanical and/or electrical connection may not exist or may exist to an insufficient degree. Often these defects are not visible to the naked eye or microscope, so sensor data is usually used to evaluate the weld joint. Current solutions for monitoring include in-process and post-process monitoring and corresponding monitoring systems. In-process monitoring is also used to control the laser welding process. Today, the monitoring of the laser welding process and the weld quality can already be carried out by a plurality of individual monitoring systems. A weakness of these individual monitoring systems is that they each use different physical quantities, e.g. geometric features in a camera image, heat radiation and process light, for evaluation and analysis and evaluate them separately from each other. However, which physical quantities are best suited for monitoring quality depends on the combination of material and process in each individual case.

Based on predefined defect criteria, it can be recognised whether the welded joint has a defect. Based on the detected defects, the weld joint can be classified as “OK” or “good weld”, i.e. the welded work pieces are suitable for further processing or for sale, or as “not OK” or “bad weld”, i.e. the welded work pieces are rejects. However, the detection of defects and the subsequent classification of the weld joint is carried out separately and independently of each other in the individual monitoring systems.

The detection of defects and the classification of the weld joint should be as reliable and automated as possible. As a rule, however, all the monitoring systems mentioned above show a so-called “false rejection”. These are welded work pieces which are classified as rejects by a monitoring system, however, in reality they are OK. It is usually more disadvantageous, however, when welded work pieces are classified as OK by a monitoring system, but in reality they are not OK. This case is referred to as “escape”.

### SUMMARY OF THE INVENTION

It is an object of the present disclosure to provide a method for monitoring a laser welding process, with the aid of which defects of a weld joint formed by the laser welding process can be determined reliably, quickly, simply and automatically.

It is an object of the present disclosure to specify a method for monitoring a laser welding process, by means of which incorrect classification of welded work pieces can be prevented or at least reduced. In particular, it is an object of the present invention to provide a method for monitoring a laser welding process by which both a false rejection rate and an escape rate during the classification of welded work pieces can be minimised.

It is further an object of the present disclosure to provide a laser welding system arranged to perform the method.

These tasks are solved by the subject matter disclosed herein of the independent claims. Advantageous embodiments and further developments are also disclosed the subject of the corresponding dependent claims.

The present disclosure is based on the basic idea that a laser welding process for welding work pieces is monitored, i.e. that it is determined whether a weld joint formed by the laser welding process has a defect, by correlating sensor data from at least two sensors. In particular, the determination of whether the weld joint has a defect can be based on sensor data from multiple sensors and optionally additionally based on at least one processing parameter of the laser welding process. The determination of whether the weld joint has a defect and the monitoring of the laser welding process are thus carried out by a combined and/or correlated evaluation of the sensor data of the multiple sensors and optionally of data on the at least one processing parameter of the laser welding process. Accordingly, determining whether the weld joint has a defect is based not only on sensor data from a single sensor, but on sensor data from multiple sensors or additionally on data from the at least one processing parameter. Determining whether the weld joint has a defect serves to evaluate the quality of the weld joint. The described procedure can significantly improve the basis for evaluating the quality of the welded joint and reduce the risk of a false evaluation, i.e. a wrong classification of the welded work pieces. Thus, the rate of false rejects and escapes can be reduced.

According to a first aspect of the present disclosure, a method for monitoring a laser welding process is disclosed, the method comprising the steps of: performing the laser welding process by irridiating a laser beam onto at least one work piece to form a weld joint, wherein the laser beam is guided along a processing path by a deflection device, detecting sensor data by at least two sensors during the laser welding process, and determining whether the weld joint has a defect based on the detected sensor data, e.g. in particular based on a correlation and/or combination of the detected sensor data. Preferably, determining whether the weld joint has a defect is also based on at least one processing parameter of the laser welding process or on a correlation and/or combination of the detected sensor data and the at least one processing parameter. In other words, determining whether the weld joint has a defect may be based on the detected sensor data and at least one processing parameter of the laser welding process.

According to a second aspect of the present disclosure a laser welding system is disclosed which is arranged to perform a laser welding process by irridiating the laser beam onto the at least one work piece and to perform the method of monitoring the laser welding process according to embodiments of the present disclosure. The laser welding system comprises a laser welding head for irridiating a laser beam onto at least one work piece to form a weld joint, wherein the laser welding head comprises a deflection device for guiding the laser beam along a processing path, at least two sensors, wherein each of the sensors is arranged to detect respective sensor data during the laser welding process, and a control unit arranged to perform a method according to any of the embodiments described herein.

The weld joint may be formed between parts or portions of a single work piece or between at least two work pieces. The weld joint may be formed by a weld, which may also be referred to as a weld bead, formed upon irridiation of the laser beam. The deflection device may also be referred to as a scanning device, scanner unit or scanner. The laser welding system may also be referred to as a scanner system. The laser welding head may also be referred to as a scanner welding head. The laser welding process may also be referred to as the laser beam welding process. Determining whether the weld joint has a defect can also be referred to as defect determination for short.

When performing the laser welding process, process radiation is usually emitted from an interaction region between the laser beam and the work piece. In particular, the interaction region can comprise a vapour capillary formed when the laser beam is irridiated and a melt pool surrounding it. The process radiation in a visible wavelength range can also be referred to as process light or plasma radiation. The process radiation in an infrared wavelength range may also be referred to as temperature radiation, infrared radiation or thermal radiation. The process radiation usually also includes a portion of the laser beam that is reflected when the laser beam is irridiated onto at least one work piece, which may also be referred to as a back reflection.

The sensor data may be based on radiation, i.e. optical measurement data. In other words, radiation emanating from the work piece and/or coupled into the laser welding head can be detected as sensor data, for example process radiation and/or a back-reflected measuring beam and/or imaging radiation. When process radiation is detected as sensor data, at least one of the two sensors may comprise a photodiode and/or be arranged to detect a radiation intensity in a predetermined wavelength range or at a predetermined wavelength.

The radiation emanating from the work piece can couple into the laser welding head and at least partially run superimposed overlap with the incident laser beam (i.e. in particular against the direction of propagation of the incident laser beam). The radiation can be coupled out of the beam path or optical path of the laser beam, e.g. by a first coupling-in device or a first beam splitter, preferably after passing the deflection device. In other words, the first beam splitter can be arranged up-stream of the deflection device in the propagation direction of the irradiated laser beam. Subsequently, the radiation coupled out of the beam path of the laser beam can be split, e.g. by a second coupling-in device or by a second beam splitter, to impinge on the first sensor and the second sensor.

The laser welding head, through which the laser beam is irradiated onto the work piece, and the work piece are preferably arranged stationarily to each other at least during the laser welding process, i.e. during the forming of the weld joint. Thus, the laser beam is preferably deflected along the processing path by the deflection device alone during the laser welding process. The processing path may correspond to a course of a desired weld. However, the present disclosure is also applicable to laser welding systems in which the work piece is moved during the laser welding process by, for example, an axis system. For example, the laser welding head may be attached to a robot. In this case, the deflection device can displace the laser beam, wherein the robot moves simultaneously or synchronously. This can save cycle time. In this case, the laser welding system can have a higher-level control unit that coordinates the movements of the robot and the deflection device.

The deflection of the laser beam along the processing path can be superimposed with an oscillating movement of the laser beam, which can also be called a wobbling movement. A wobbling movement is usually defined as an oscillating movement of the laser beam around an actual processing position along the processing path, the amplitude of which can correspond approximately to a width of a resulting weld. A processing speed can be defined as a speed at which the laser beam is irradiated and deflected along the processing path. A superimposed wobbling motion of the laser beam can be disregarded. When the laser beam performs a wobbling motion, the processing speed can be designated as an average speed of the laser beam along the processing path. Alternatively, the processing speed may be defined as a speed of the current processing position along the processing path.

One or more of the above aspects may have one or more of the following optional features:

The deflection device may be arranged to deflect the laser beam within a scanning field of the deflection device on the at least one work piece.

When it is determined that the weld joint has a defect, the weld joint and/or the welded work piece may be classified as a “bad weld”, as “not OK” and/or as a reject. When it is determined that the weld joint has no defect, the weld joint and/or welded work piece may be classified as a “good weld” and/or as “OK”. A weld joint falsely classified as a “good weld” may be designated as an “escape”. A weld joint falsely classified as a reject may be referred to as a “false reject”.

The processing parameter considered in the defect determination may include at least one of the following parameters: an alignment of the laser welding head to the at least one work piece, an angle of incidence of the laser beam on the at least one work piece, a position of the laser beam within a scanning field of the deflection device, a displacement of the laser beam by the deflection device from a zero position, a focal position of the laser beam, a focal diameter of the laser beam, a focal shape of the laser beam, a processing speed, a processing direction, a velocity vector of the laser beam along the processing path, a position of the at least one work piece within the scanning field of the deflection device, a position of the processing path within the scanning field of the deflection device, a material and/or a thickness of the work piece, an adjustment speed of a deflection element of the deflection device, a position and/or an adjustment angle of a deflection element of the deflection device.

The defect determination can be based on nominal values for the processing parameter. The-nominal values can be specified during the laser welding process, in particular during the formation of the weld joint. The nominal values can be provided in real time for the defect determination. The nominal values can be time-resolved or time-dependent and/or time-independent nominal values, in particular averaged over the laser welding process. The nominal values can be provided, for example, by a control unit of the laser welding head, in particular a control unit of the deflection device, or by the higher-level control unit, i.e. they are preferably not measured.

The at least two sensors for detecting the sensor data may comprise at least two of the following sensors: a first intensity sensor, preferably comprising a photodiode, arranged to detect first intensity data of a radiation intensity of the process radiation emitted during the laser welding process in a visible wavelength range: a second intensity sensor, preferably comprising a photodiode, arranged to detect second intensity data of a radiation intensity of the process radiation in an infrared wavelength range: a third intensity sensor, preferably comprising a photodiode, arranged to detect third intensity data of a radiation intensity of a laser beam reflected back from a surface of the work pieces: a sensor, preferably a photodiode, arranged to detect fourth intensity data of a radiation intensity of the laser beam for detecting an actual irradiated power of the laser beam: an image sensor, preferably a camera, arranged to detect image data or for taking an image of a surface of the work pieces: a distance sensor, preferably an optical coherence tomograph, arranged to detect distance data of a distance between the laser welding head irridiating the laser beam and the work piece and/or arranged to detect distance data of a depth of a vapour capillary generated during the laser welding process and/or arranged to detect surface profile data of a surface of a weld formed by the laser welding process. The power of the laser beam may also be referred to as laser power. The image sensor is preferably arranged coaxially, i.e. coaxially to the beam path of the laser beam or to the optical axis of the laser welding head. Preferably, the process radiation or the radiation detected by at least one of the sensors can be separated from the laser beam by a beam splitter, such as a dichroic mirror.

The detection of the sensor data may comprise at least two of the following steps: detecting first intensity data of a radiation intensity of the emitted process radiation in a visible wavelength range, detecting second intensity data of a radiation intensity of the process radiation emitted during the laser welding process in an infrared wavelength range, detecting third intensity data of a radiation intensity of a laser radiation back-reflected from the at least one work piece at a wavelength of the laser beam, detecting fourth intensity data of a radiation intensity of the irradiated laser beam at a wavelength of the laser beam to determine a current irradiated laser power, detecting image data by taking an image and/or video of a surface of the work piece, detecting surface profile data of the surface of the weld, and detecting distance data of a distance to the work piece and/or a depth of a vapour capillary generated during the laser welding process.

Accordingly, the detected sensor data may comprise at least two, in particular two different, of the following sensor data: image data comprising at least one image of a surface of the at least one work piece and/or an image of the vapour capillary and/or the melt pool, measurement values of a radiation intensity of the process radiation in a predetermined wavelength range or at a predetermined wavelength, measurement values of a radiation intensity of the process radiation in a visible wavelength range, measurement values of a radiation intensity of the process radiation in an infrared wavelength range, measurement values of a radiation intensity of the laser radiation reflected back from the work pieces, measurement values of a radiation intensity of the irradiated laser beam, surface profile data of the weld, measurement values of a distance to the work piece, and measurement values of the depth of the vapour capillary generated during the laser welding process.

According to preferred embodiments, the at least one processing parameter comprises at least one parameter of the deflection device, for example the position and/or the adjustment angle of the deflection element of the deflection device, the angle of incidence of the laser beam on the at least one work piece, the position of the laser beam within the scanning field of the deflection device, the displacement of the laser beam through the deflection device from a zero position, the position of the laser beam within the scanning field of the deflection device, the position of the at least one work piece within the scanning field of the deflection device, the position of the processing path within the scanning field of the deflection device, and/or the adjustment speed of a deflection element of the deflection device. By including at least one of these processing parameters of the deflection device when determining whether the weld has a defect, the reliability and quality of the defect determination can be improved. This is particularly advantageous for laser welding systems in which the defect determination is based on radiation, in particular the process radiation, which passes at least in sections through optical elements of the laser welding system, for example the deflection device and a focusing optics, e.g. an F-theta lens. Operating parameters of the deflection device, for example the position of a deflection element of the deflection device, can have an influence on the sensor data detected for defect determination, for example on the process radiation for detecting the first to third intensity data, the optical measuring beam for detecting the distance data, the surface profile data and/or on the detection of the image data. In particular, processing parameters of the deflection device may have an influence on a signal level of the corresponding sensor data. The focusing optics is usually optimised only for the wavelength of the laser beam. When passing through the focusing optics, chromatic aberration can therefore occur with radiation of a different wavelength than the wavelength of the laser beam. By including and taking into account the aforementioned processing parameters in the defect determination, the influences of the focusing optics and the deflection device on the sensor data can be reduced in the defect determination.

Preferably, the sensor data and the data of the processing parameter, in particular the nominal values of the processing parameter, correspond to each other, e.g. in terms of time and/or space. This can mean that the data were detected or recorded during the same predetermined time period or at the same location. Furthermore, it may mean that corresponding data or values are available for predetermined points in time within a predetermined period of time. For this purpose, the sensor data and/or the data of the processing parameter can be detected or recorded with the same sampling frequency. Alternatively, the data may be interpolated or data may be discarded.

Determining whether there is a defect in the weld joint can be done during the performance of the laser welding process, in particular in real time, and/or after the performance of the laser welding process. Accordingly, the method for monitoring a laser welding process can be formed as an in-process or post-process method. The detection of sensor data and/or determining whether there is a defect in the weld joint can be performed continuously and/or repeatedly during the performance of the laser welding process.

Determining whether the weld joint has a defect may include determining whether the weld joint has at least one of the following defects: a lack of or insufficient physical and/or electrical and/or mechanical connection through the weld joint between welded work pieces and/or a gap between welded work pieces. For example, it may be determined that the weld joint has a defect when the conductivity of the electrical connection through the weld joint is equal to or less than a predetermined conductivity threshold. Further, it may be determined that the weld joint has a defect when the size of the gap between work pieces welded in lap or parallel joint is equal to or greater than a gap threshold.

Determining whether the weld joint has a defect can be done by algorithms and/or by a machine learning method, in particular using an artificial neural network.

Determining whether the weld joint has a defect may comprise: separately evaluating the sensor data for each of the at least two sensors, combining the evaluations by a logic operation, and determining whether the weld joint has a defect based on the combined evaluation. The separate evaluation of the sensor data for each of the at least two sensors can be performed taking into account the at least one processing parameter. Alternatively, the sensor data for one or some of the at least two sensors can be evaluated taking into account the at least one processing parameter.

For example, the sensor data for at least one of the sensors can be evaluated separately to determine whether the weld joint has a defect based on the sensor data of this sensor alone. This can be done in a conventional way to determine the defect. For example, an intensity curve of the process radiation emitted during the laser welding process in a visible wavelength range corresponding to the process light and in an infrared wavelength range corresponding to the heat radiation and an intensity curve of the laser radiation reflected back can be measured by means of a photodiode and a corresponding intensity signal is generated based on this. Subsequently, the intensity signals can be analysed separately, for example by comparing the respective intensity signal with corresponding reference curves or envelopes. Based on predefined defect criteria, it can be recognised whether the weld joint has a defect according to the evaluation of the respective intensity signal. Defect criteria can be defined, for example, as a function of an integral of the curves over the envelope curves or of an undershoot or overshoot of the envelope curves. In the case of an image of the weld pool as sensor data, geometric features of the weld pool, in particular shape, size and/or position of the weld pool, can be detected by means of image processing. Based on deviations from predefined geometries, it can be recognised here whether the weld joint has a defect.

The results of the separate evaluations can then be linked by a logical “and” operation. This can reduce the rate or probability of escapes. Alternatively or additionally, the results can be linked by a logical “or” operation. This can reduce the rate or probability of false rejects.

Here, a first group of sensors whose results of the separate evaluations are linked “and” and a second group of sensors whose results of the separate evaluations are linked “or” may each have at least two sensors, and the first group and the second group may have at least one sensor that is not included in the other group. Thus, when using more than two sensors, for example three sensors, a combination of the two evaluation methods is possible to reduce escapes and false rejects simultaneously.

Based on the defect determination, in particular when it has been determined that the weld joint has a defect, the laser welding process can be controlled by adjusting or setting at least one processing parameter, in particular the laser power, the processing speed and/or the focal position of the laser beam. For example, a correlation of the detected sensor signals can be used to control the laser power. In another example, a variable z-collimation can be used to set or adjust the focal position of the laser beam based on the detected sensor signals, in particular based on a correlation and/or combination of the detected sensor signals. The control can be performed by the control unit of the laser welding system or a higher-level control unit. Determining whether the weld has a defect can be done while performing the laser welding process. The adjustment of at least one processing parameter may comprise the adjustment of the same processing parameter based on which the defect determination was performed and/or the adjustment of another processing parameter of the laser welding process, wherein the other processing parameter is not the same as the one used for the defect determination.

The sensor data used for defect determination may be raw data. Thus, determining whether the weld joint has a defect can be done without any pre-processing of the detected sensor data. For example, an artificial neural network can determine directly based on the raw data whether the weld joint has a defect. This can also be referred to as “end-to-end” processing. This allows the defect determination to be more reliable and faster. Furthermore, the defect determination can be done in real time and the monitoring of the laser welding process and control of the laser welding process can be done more reliably and accurately.

Alternatively, the sensor data of at least two sensors can be pre-processed or pre-evaluated before the defect determination. This can be done, for example, by a processing unit of the laser welding system. The processing unit can have an FPGA (“Field Programmable Gate Array.”). The functionality of the processing unit can be implemented by the control unit or the processing unit can be integrated into the control unit. In particular, the sensor data can be linked to the at least one processing parameter in such a way that the data correspond in time. For example, the detected sensor data, in particular one or more of the first to fourth intensity signals, can be linked to at least one processing parameter of the deflection device, e.g. to a position of the laser welding head in a scanning field of the deflection device, a processing speed, a position, a position and/or an adjustment angle of a deflection element of the deflection device, a speed of a change of position and/or an adjustment speed of the deflection element of the deflection device. In this way, the speed of the subsequent evaluation of the sensor data and the processing parameter and the defect determination can be optimised or increased.

The deflection device can be arranged to deflect the laser beam by at least a first deflection angle along a first axis. Preferably, the deflection device is additionally arranged to deflect the laser beam through a second deflection angle along a second axis, wherein the first and second axes are arranged at an angle to each other, for example perpendicular to each other. The maximum first deflection angle and/or the maximum second deflection angle of the deflection device may each be equal to or greater than 10 degrees, in particular 10 to 20 degrees. If the deflection device has mirrors as deflection elements, these maximum deflection angles correspond to maximum mirror angles of at least 5 degrees, in particular 10 degrees, since the laser beam is deflected by twice the mirror angle.

The scanning field of the deflection device may be defined as a region on the work piece or on the work piece surface, and/or may be predetermined by a maximum first and a maximum second deflection angle of the first deflection device. A length and/or a width of the scanning field may be equal to or greater than 50 mm. For example, the scanning field may have a size greater than 50 mm×50 mm, in particular equal to or greater than about 100 mm×200 mm or 250 mm×150 mm, on the work piece. According to embodiments, the scanning field has an elliptical shape. In this case, the length of the scanning field may indicate the length of the major axis of the ellipse and the width of the scanning field may indicate the length of the minor axis of the ellipse. The deflection device may be formed as a large field scanner.

To cause the deflection of the laser beam, the deflection device may have a first movable mirror and a second movable mirror. The first movable mirror can be rotatable about a first axis of rotation and the second movable mirror can be rotatable about a second axis of rotation, wherein the first axis of rotation and the second axis of rotation are at an angle to each other, e.g. at an angle between 45° and 135°, in particular of about 75° or of 90°. For this purpose, the mirror or the first and second mirrors can be formed as galvanometer mirrors, in short galvo mirrors. Alternatively, the deflection device can have a movable mirror which can be rotated or pivoted about at least two axes. Accordingly, the deflection device can be formed as a galvanometer or galvo scanner. Alternatively, the deflection device may have MEMS-based, piezoelectric and/or inductive actuators. Alternatively, the deflection device may be formed as a prism scanner or lens scanner.

The laser welding system, in particular the laser welding head, may comprise a first coupling-in device for coupling the laser beam into the deflection device and for coupling out the radiation emanating from the work piece from a beam path of the laser beam. The first coupling-in device can be arranged upstream of the deflection device in the direction of propagation of the irradiated laser beam. Furthermore, the laser welding system, in particular the laser welding head, may comprise a second coupling-in device for splitting the radiation coupled out of the beam path of the laser beam. The second coupling-in device may be arranged to direct a portion of the radiation to a first of the at least two sensors and another portion of the radiation to a second of the at least two sensors.

The laser welding system, in particular the laser welding head, may comprise collimating optics for adjusting the focal position of the laser beam. The collimating optics can be adjusted along an optical axis of the collimating optics and/or along a beam propagation direction of the laser beam to set the focal position of the laser beam. The collimating optics may comprise two or more lenses, the distances between which are at least partially variable. The adjustment may be motorised. The control unit can control the collimating optics to adjust the focal position of the laser beam.

The laser welding system, in particular the laser welding head, may further comprise focusing optics for focusing the laser beam. The focussing optics may comprise two or more lenses, the distances between which are at least partially variable in order to set or change the focal position. The focusing optics can be arranged in particular to focus the laser beam on the work piece, in particular on a surface of the at least one work piece. The focusing optics may comprise an F-theta lens or be formed as such. The F-theta lens can be formed telecentrically.

The control unit may be arranged to control the laser welding system, in particular the laser welding head, the at least two sensors, the deflection device, the focusing optics, the collimating optics and/or a laser source for generating the laser beam, in order to perform the laser welding process and the method for monitoring the laser welding process.

Furthermore, the laser welding system may have an interface for transmitting the sensor data and processing parameter data, in particular nominal values, to an external control unit or the higher-level control unit, for example an external computer.

In addition, the laser welding system can have a ring light. The ring light can have separately switchable segments. With the help of the ring light, an image or video with a high contrast can be obtained by the image sensor. Using the ring light, a very high-contrast image can be accom-modated in a so-called “shape-by-shading” method. In addition, the laser welding system can have a line generator for triangulation. Using lines generated by the line generator on the surface of at least one work piece, the image sensor can detect a geometry of the surface and/or a geometry of a weld formed by the laser welding process. Based thereon, the image sensor may detect geometry data as sensor data.

The at least one work piece may comprise one of the following elements: a battery, a battery cell, a battery pack, a battery terminal, an arrester, and/or a portion of these elements. For example, the at least one work piece may comprise a battery cell and an arrester. By means of the weld formed by the laser welding process, an electrical connection may be made between the battery cell and the arrester.

### BRIEF DESCRIPTION OF THE DRAWINGS

The invention is described in detail below with reference to figures.

FIG. 1 shows a schematic view of a laser welding system according to embodiments of the present disclosure:

FIG. 2 shows a schematic view illustrating a scanning field of a deflection device of a laser welding system according to embodiments of the present disclosure:

FIG. 3 shows a flowchart of a method for monitoring a laser welding process according to embodiments of the present disclosure: and

FIG. 4 shows a schematic view of multiple work piece groups in a scanning field of a deflection device of a laser welding system according to embodiments for illustrating a method for monitoring a laser welding process according to embodiments of the present disclosure.

### DETAILED DESCRIPTION OF THE INVENTION

In the following, unless otherwise noted, the same reference signs are used for the same and similarly acting elements.

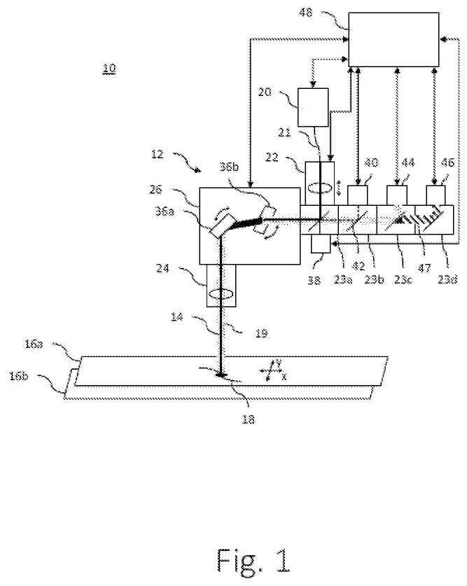

FIG. 1 shows a schematic view of a laser welding system according to embodiments of the present disclosure.

The laser welding system 10 comprises a laser welding head 12 for irridiating and directing a laser beam 14 onto at least one work piece. The laser welding system 10 is arranged to perform a laser welding process for welding the at least one work piece. According to the embodiment shown in FIG. 1, the laser welding system 10 is arranged to weld two work pieces 16a, 16b together. The two work pieces 16a, 16b are arranged in an overlap joint and the irridiation of the laser beam 14 is performed on the work piece 16a above, but the present disclosure is not limited thereto. The work pieces 16a, 16b can, for example, also be arranged in a parallel joint or in a butt joint and the irridiation of the laser beam 14 can take place on both work pieces 16a, 16b. According to embodiments, welding of the at least one work piece can comprise welding of parts or regions of a single work piece. In this case, the work pieces 16a, 16b shown in FIG. 1 may be considered as parts or portions of this single work piece.

Welding of the work pieces 16a, 16b is accomplished by irridiating the laser beam 14 onto the work pieces 16a, 16b and moving the laser beam 14 along a predetermined processing path 18 on the work pieces 16a, 16b. The processing path 18 may be located on one of the work pieces 16a, 16b. According to embodiments, the processing path may be arranged on both or on a boundary between the work pieces 16a. 16b. The predetermined processing path 18 indicates the course of a desired weld. The weld forms the weld joint between the work pieces 16a, 16b to be formed by the laser welding process. When the laser beam is irradiated onto the work pieces 16a, 16b, a vapour capillary, also referred to as a keyhole, is formed in a region between the surface of the work pieces 16a, 16b onto which the laser beam is irradiated, up to a certain depth within the work pieces 16a, 16b. In the region of the vapour capillary, the material of the work piece heats up so much due to the laser power that it vaporises. The vapour capillary is surrounded by a melt pool in which the material is melted. As the material cools, the weld joint is formed.

The laser welding system 10 may be coupled to a laser source 20 for generating the laser beam 14, also referred to as a processing laser beam, to couple the laser beam 14 into the laser welding head 12. The laser source 20 may be formed as a single mode laser, a solid state laser or a fibre laser. The laser beam 14 is transmitted from the laser source 20 to the laser welding head 12 via an optical fibre 21 and coupled into the laser welding head 12 from one end of the optical fibre 21, e.g. by means of a fibre coupler (not shown). A collimating optics 22 arranged downstream of the fibre coupler is arranged to collimate the laser beam 14 emerging divergently from the end of the optical fibre 21. With the aid of the collimating optics 22, the focal position of the laser beam 14 can be adjusted or corrected. The axis along which a focal position of the laser beam 14 can be set can correspond to an optical axis of the laser welding head 12, in particular an optical axis of a focusing optics 24. This axis can also be referred to as the z-axis. Accordingly, the collimator optics 22 may be referred to as (variable) z-collimator optics or (variable) z-collimation for short. The focal position may be set by moving a lens of the collimator optics 22 along the optical axis of the collimator optics 22 or a beam axis of the laser beam 14. The collimator optics 22 may have a motor unit (not shown) for adjusting the lens. The collimator optics 22 can be controlled by a higher-level control unit (not shown) of the laser welding system 10 or the control unit 48. With the aid of the z-collimation, the focal position of the laser beam 14 can be suitably set in dependence on the sensor signals of the sensors described below.

The laser welding system 10 further comprises a first coupling-in device 23a for coupling the laser beam 14 into the laser welding head 12 or into the deflection device 26. The first coupling-in device 23a is configured as a beam splitter and comprises, for example, a dichroic mirror which substantially reflects light having the wavelength of the laser beam 14 and substantially allows light having a wavelength other than that of the laser beam 14 to pass, i.e. the mirror is substantially transparent for light having a wavelength other than that of the laser beam 14. With the aid of the first coupling device 23a, process radiation detected as sensor signals by the sensors described below can be separated from the laser beam 14 after passing through the deflection device 26. In addition, the laser welding head 12 comprises focusing optics 24 for focusing the laser beam 12 on the at least one work piece 16a, 16b, in particular on a surface of the at least one work piece 16a, 16b. According to embodiments, the focusing optics 24 may be formed as an F-theta lens.

In order to change the position of the laser beam 14 on the at least one work piece 16a, 16b, and in particular in order to guide the laser beam 14 along the processing path 18, the laser welding system 10 further comprises a deflection device 26 for deflecting or displacing the laser beam 14 relative to the at least one work piece 16a, 16b. The deflection device 26 is arranged to move or deflect the laser beam 14 along two axes x, y. According to embodiments, the two axes x, y can be perpendicular to each other and define an x-y plane which is arranged parallel to a surface of the at least one work piece 16a. 16b, but the present disclosure is not limited thereto. The deflection device 26 may also be referred to as a scanning unit or scanner.

With the aid of the deflection device 26, the processing path 18 can be traversed by the laser beam 14. A processing speed may be defined as a speed at which the laser beam 14 is irradiated and deflected along the processing path 18. Any superimposed wobbling motion of the laser beam 14 may be disregarded. When the laser beam performs a wobbling motion, the processing speed can be described as an average speed of the laser beam 14 along the processing path.

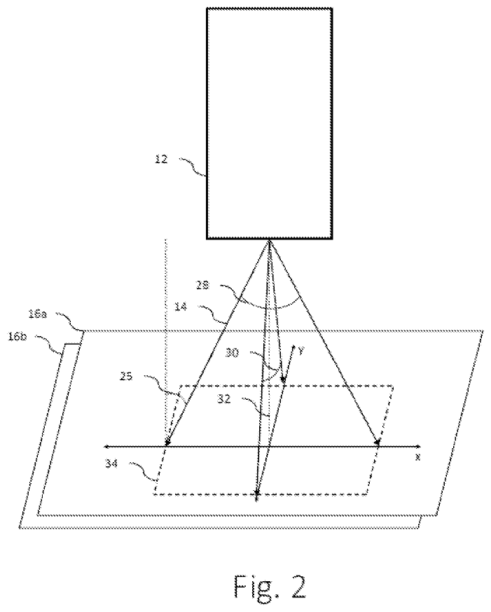

FIG. 2 shows a schematic view illustrating a scanning field of the deflection device 26. The deflection device 26 is arranged to deflect the laser beam 14 along the x-axis by a first deflection angle and to deflect the laser beam 14 along the y-axis by a second deflection angle. The deflection device 26 comprises a zero position with respect to the x-axis and with respect to the y-axis, for which the laser beam 14 assumes a zero position along the respective axis. The zero position of the x-axis and the zero position of the y-axis can be considered together as the centre or centre 32 of a scanning field 34 of the deflection device 26. The centre 32 of the scanning field 34 may correspond to a non-deflected position of the laser beam 14, i.e. a (general) zero position of the laser beam 14. In the non-deflected position of the laser beam 14, the laser beam 14 may extend between the laser welding head 12 and the at least one work piece 16a. 16b coaxially with an optical axis of the laser welding head 12 and/or an optical axis-se of the focusing optics 24.

A maximum first deflection angle 28 along the x-axis (i.e. rotation about y-axis) and a maximum second deflection angle 30 along the y-axis (i.e. rotation about x-axis) define an edge of the scanning field 34 on the surface of the at least one work piece 16a, 16b within which the deflection device 26 can deflect the laser beam 14 with respect to the at least one work piece 16a, 16b. According to embodiments, the deflection device 26 is formed as a large field scanner. For example, the maximum first deflection angle 28 and/or the maximum second deflection angle 30 may be greater than 10 degrees. The first and second maximum deflection angles 28, 30 may be predetermined by design. Alternatively, an F-theta lens used as focusing optics 24 can limit the maximum deflection angles 28, 30.

FIG. 2 shows the scanning field 34 with a rectangular shape, but the present disclosure is not limited to this. The scanning field 34 may also have a circular or elliptical shape. In this case, the rectangle shown in FIG. 2 can be considered as a rectangle with the largest area inscribed in the elliptical first scanning field.

In order to cause the deflection of the laser beam 14, the deflection device 26 comprises at least one deflection element. According to embodiments, the deflection device 26 comprises as deflection element two movable mirrors 36a, 36b (see FIG. 1), which are rotatable or adjustable about different axes of rotation. The mirrors 36a, 36b can be formed as galvanometer mirrors. In this case, the deflection device 26 may be referred to as a galvanometer scanner or galvo scanner. According to alternative embodiments not shown, the deflection device comprises as a deflection element a movable mirror which is adjustable about at least two axes. The position or the adjustment angle of the at least one deflection element thus determine the deflection of the laser beam 14 from the zero position 32, the position of the laser beam 14 in the scanning field 34 and the angle of incidence 25 of the laser beam 14 on the at least one work piece 16a, 16b. The angle of incidence 25 is defined as the angle between a normal to the surface and the laser beam 14.

A control unit (not shown) of the deflection device 26, which may also be the control unit of the laser welding system 10, may be arranged to transmit current nominal values of at least one processing parameter of the laser welding process to the control unit 48 of the laser welding system 10 during the laser welding process. The at least one processing parameter may comprise, for example, one of the following parameters of the deflection device 26: the angle of incidence 25 of the laser beam 14, the position of the laser beam 14 in the scanning field of the deflection device 26, a displacement of the laser beam 14 by the deflection device 26 from the zero position 32, the processing speed, a processing direction, a velocity vector of the laser beam 14 along the processing path 18, and a position or adjustment, an adjustment angle and/or an adjustment speed of the at least one deflection element of the deflection device 26, for example the mirrors 36a, 36b.

According to embodiments, the laser welding head 12 and/or the at least one work piece 16a, 16b can additionally be moved relative to each other, preferably between two successive laser welding processes. For example, the at least one work piece 16a, 16b can be moved relative to the laser welding head 12 by a first movement unit (not shown). Alternatively or additionally, the laser welding head 12 can be moved relative to the at least one work piece 16a, 16b by a second movement unit (not shown). The second movement unit may, for example, be formed as a robot and the laser welding head 12 may be attached to the robot. During a laser welding process, i.e. during the forming of a weld, the laser welding head 12 or the laser welding system 10 preferably remains stationary relative to the at least one work piece 16a, 16b.

During the performance of the laser welding process, emission is emitted from a region of interaction between the laser beam 14 and the at least one work piece 16a, 16b. In particular, the interaction region can encompass the vapour capillary and the melt pool. The process radiation in a visible wavelength range can also be referred to as process light or plasma radiation. The process radiation in an infrared wavelength range can also be referred to as temperature radiation. The process radiation further comprises a portion of the reflected portion of the laser beam 14 when the laser beam 14 is irridiated onto the at least one work piece 16a, 16b. This reflected portion may also be referred to as a back reflection.

A portion 19 of the process radiation is coupled back into the laser welding head 12 or the laser welding system 10 and runs at least partially superimposed on the laser beam 14. Starting from the at least one work piece 16a, 16b, this portion 19 of the process radiation enters the laser welding head 12 via the focusing optics 24 and is also deflected by the deflection device 26. Subsequently, the portion 19 is coupled out of the beam path of the laser beam 14 by the first coupling-in device 23a. The radiation intensity of this portion 19 is detected by sensors at predetermined wavelengths or in predetermined wavelength ranges, as described in detail below.

The position of the at least one deflection element of the deflection device 26 and thus the angle of incidence 25 of the laser beam 14 on the at least one work piece 16a, 16b have an influence on the spectral distribution of the radiation intensity of the process radiation portion 19 and of the optical measuring beam 43 and on the detection of image data, as described in the following. The position of the at least one deflection element of the deflection device 26 and the angle of incidence 25 of the laser beam 14 on the at least one work piece 16a, 16b therefore also determine a signal level of the sensor data output by the corresponding sensors.

The laser welding system 10 has multiple sensors for detecting sensor data during the laser welding process. The sensors may also be referred to as sensor system. The sensor system is preferably integrated into or attached to the laser welding head 12. In the embodiment shown in FIG. 1, the laser welding system 10 has a measuring device 40 for interferometric distance measurement or for optical distance measurement with the aid of an optical measuring beam 42. The measuring device 40 is arranged to measure a distance between the laser welding head 12 and the at least one work piece 16a, 16b and/or to measure a depth of the vapour capillary during the laser welding process. The measuring device 40 is arranged to transmit distance data to the control unit as sensor data. The distance data may comprise values of the measured distance and/or values of the measured depth. The measuring device 40 may further be arranged to detect or scan a surface profile of a surface of the weld formed by the laser welding process. In particular, this may be performed after the laser welding process has been performed. The detection of the surface profile can also be referred to as a downstream inspection of the weld or weld bead. The measuring device 40 may be arranged to transmit corresponding surface profile data to the control unit as sensor data.

According to embodiments, the measuring device 40 comprises an optical coherence tomograph or may be formed as an optical coherence tomograph. In other words, the distance measurement may be based on optical coherence tomography (OCT). This type of distance measurement is based on the principle of making use of the coherence properties of light with the aid of an interfer-ometer. For this purpose, the optical measuring beam 42 is irradiated onto the at least one work piece 16a, 16b. The portion of the optical measuring beam 42 reflected back from at least one work piece 16a, 16b is superimposed with light from a reference arm (not shown) and caused to interfere. By evaluating the superimposed light, information can be obtained about the distance to the at least one work piece 16a, 16b, the surface profile of the weld or about the depth of the vapour capillary.

The laser welding system 10 comprises a second coupling-in device 23b for coupling the optical measuring beam 42 into the laser welding head 16 and for superimposing the laser beam 14 on the optical measuring beam 42. The second coupling-in device 23b is formed as a beam splitter and comprises, for example, a dichroic mirror which substantially reflects light having the wavelength of the optical measuring beam 42 and substantially allows light having a wavelength other than that of the optical measuring beam 42 to pass. The optical measuring beam 42 is thus reflected and deflected by the dichroic mirror of the second coupling-in device 23b and passes through the dichroic mirror of the first coupling-in device 23a to be coupled into the laser welding head 12 or the deflection device 26. After passing through the deflection device 26 and the focusing optics 24, the optical measuring beam 24 impinges on the surface of at least one work piece 16a, 16b.

The laser welding system 10 further comprises a sensor unit 44 for measuring a radiation intensity of the process radiation coupled into the laser welding head 12. For this purpose, the laser welding system 10 has a third coupling-in device 23c arranged to direct a portion of the process radiation into the sensor unit 44. The third coupling-in device 23c is formed as a beam splitter and has, for example, a partially transparent mirror so that the process radiation partially passes the third cou-pling-in device 23c.

The sensor unit 44 has intensity sensors (not shown) for detecting intensity data. For example, a first intensity sensor of the sensor unit is arranged to measure a radiation intensity of the process radiation entering the sensor unit 44 in a visible wavelength range and to output a first intensity signal based thereon. The first intensity sensor is arranged to measure the radiation intensity of the plasma radiation. Based on this, the process light can be evaluated. The first intensity signal can comprise measurement values of the radiation intensity of the process radiation in the visible wavelength range. The measurement values may be transmitted to the control unit 48 as first intensity data.

A second intensity sensor is arranged, for example, to measure a radiation intensity of the process radiation in the infrared wavelength range and to output a first intensity signal based thereon. The second intensity sensor is arranged to measure the radiation intensity of the infrared or temperature radiation. Based on this, the melt pool dynamics can be evaluated. The second intensity signal may comprise measurement values of the radiation intensity of the process radiation in the infrared wavelength range. The measurement values may be transmitted to the control unit 48 as see-ond intensity data.

A third intensity sensor is arranged, for example, to measure a radiation intensity of the process radiation at a wavelength of the laser beam and to output a first intensity signal based thereon. The third intensity sensor is arranged to measure the radiation intensity of the back reflection. The third intensity signal may comprise measurement values of the radiation intensity of the process radiation at the wavelength of the laser beam. The measurement values may be transmitted to the control unit 48 as third intensity data.

The sensor unit 44 is not limited to a combination of the first to third intensity sensors, but may also comprise only one or two of these intensity sensors. The intensity sensors are preferably formed as photodiodes.

In the embodiment shown in FIG. 1, the laser welding system 10 further comprises a fourth intensity sensor 38 for detecting or determining an irradiated power of the laser beam 14. The fourth intensity sensor 38 is arranged to measure a radiation intensity at the wavelength of the laser beam 14 and to output an intensity signal based thereon. The intensity signal may comprise measurement values of the radiation intensity. Based on the measured radiation intensity, the actual or irradiated or used power of the laser beam 14 can be determined. The fourth intensity sensor 38 is arranged to transmit fourth intensity data to the control unit. The measurement values can be transmitted to the control unit 48 as fourth intensity data. Alternatively, the intensity data may comprise determined values of the irradiated power of the laser beam 14.

Unlike the third intensity sensor of the sensor unit 44, the fourth intensity sensor does not receive the radiation intensity of the back reflection. As shown in FIG. 1, the intensity sensor 38 is arranged such that the portion of the laser beam 14 emitted from the collimating optics 22 which has not been re-reflected and deflected by the first coupling-in device 23a impinges on the fourth intensity sensor 38. The fourth intensity sensor 38 thus measures the radiation intensity of laser beam 14 that has not previously been reflected by at least one work piece 16a, 16b. The measured radiation intensity is therefore not influenced by the processes in the interaction zone between the laser beam 14 and the at least one work piece 16a, 16b. Based on this measured radiation intensity, the irradiated power of the laser beam 14 can therefore be determined and verified.

Further, the laser welding system 10 comprises an image sensor 46 arranged to generate image data. The image sensor 46 may also be referred to as a vision system. For example, the image sensor 46 may comprise a camera (not shown), or may be formed as a camera. The image sensor 46 is arranged to detect a radiation intensity of radiation 47 from the surface of the at least one work piece 18a, 18b. The radiation 47 may comprise light in the visible wavelength range and/or in the infrared wavelength range, and may in particular comprise a portion of the process radiation that has passed through the third coupling-in device 23a. The radiation 47 may be directed to the image sensor 46 by a fourth coupling-in device 23d. The fourth coupling-in device 23d may comprise a mirror. The image sensor 46 is arranged to detect an intensity of the radiation 47. Since in the laser welding system 10 shown in FIG. 1 the radiation 47 runs at least partially superimposed, in particular coaxially, with the laser beam 14, the arrangement of the image sensor 46 shown in FIG. 1 can also be referred to as a coaxial arrangement.

The image sensor 46 is arranged in particular to detect the intensity of the radiation 47 with frequency and/or spatial resolution and to accommodate an image of the surface of the at least one work piece 16a, 16b based on the detected intensity. The image may in particular show a region of the surface of the at least one work piece 16a, 16b with the vapour capillary and the melt pool. The image may be a colour image or a grey scale image. The image sensor 46 may be arranged to continuously or repeatedly capture images during the laser welding process. The image sensor 46 is arranged to transmit the captured image(s) as image data to the control unit 48. The image sensor 46 may be arranged to capture a video of the surface of at least one work piece 16a, 16b. In this case, one frame of the video may be considered as one image. The image sensor 46 may already perform image (pre-)processing of the captured image before it is transmitted to the control unit.

The disclosure is not limited to the configuration of the laser welding system 10 and/or the laser welding head 12 shown in FIG. 1. In particular, the laser welding system 10 and/or the laser welding head 12 may comprise only two or three of the sensors 38, 40, 44 and 46.

The control unit 48 is arranged to receive the sensor data and is arranged to receive nominal values of the at least one processing parameter. The control unit 48 is arranged to determine, based on the sensor data from at least two of the sensors and based on the at least one processing parameter, whether the weld joint formed by the laser welding process has a defect. The control unit 48 is further arranged to control the laser welding head 12, in particular the deflection device 26 and the collimating optics 22, to perform the laser welding process. Alternatively, this functionality may be implemented by a control unit of the laser welding head 12, for example the control unit of the deflection device 26, or by the higher-level control unit. The control unit 48 is arranged to control the laser welding system 10, in particular the laser welding head 12 and the sensors, to perform the method for monitoring the laser welding process.

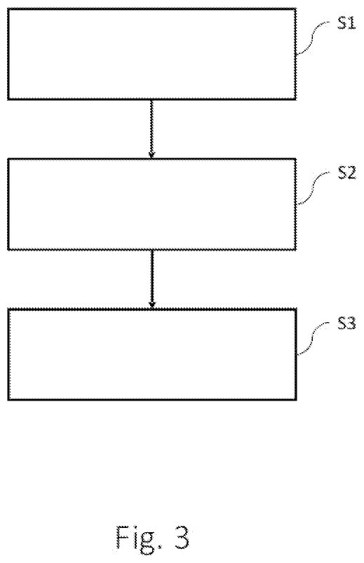

FIG. 3 shows a flowchart of the method for monitoring a laser welding process according to embodiments of the present disclosure. The method can be performed by the laser welding system 10 according to FIG. 1.

The method comprises performing the laser welding process according to embodiments of the present disclosure by irridiating a laser beam onto at least one work piece to form a weld joint (S1). In doing so, the laser beam is guided along a processing path by a deflection device. The laser welding process can be performed, for example, by the laser welding system 10 according to FIG. 1 for welding the two work pieces 16a, 16b.

During the laser welding process, sensor data is detected by at least two sensors (S2). The at least two sensors may comprise the two sensors of the laser welding system 10 of FIG. 1. For example, the at least two sensors may comprise the first to third intensity sensors. According to embodiments, the sensor data are detected in real time during the laser welding process and comprise current sensor data of the respective sensors.

As a further step (S3), the method comprises determining whether the weld joint formed by the laser welding process has a defect based on the detected sensor data. Preferably, determining whether the weld joint formed by the laser welding process has a defect is additionally based on at least one processing parameter of the laser welding process. According to embodiments, the determination of whether the weld joint has a defect is based on nominal data of the at least one processing parameter recorded or detected during the laser welding process, in particular during the formation of the weld joint.

Determining whether the weld joint has a defect may also be referred to as defect determination for short. According to embodiments, determining whether the weld joint has a defect is performed by machine learning methods, in particular using an artificial neural network. For example, it can be determined that the weld joint has a defect when the conductivity of the electrical connection through the weld joint between the work pieces 16a, 16b is equal to or less than a predetermined conductivity threshold. It can further be determined that the weld joint has a defect when the size of the gap between work pieces 16a, 16b welded in the lap joint is equal to or greater than a gap threshold.

According to embodiments, the defect determination is performed after the laser welding process has been performed. When it is determined that the weld joint has a defect, the weld joint or welded work piece may be classified as “not OK”, poor weld and/or reject. When it is determined that the weld joint has no defect, the weld joint or welded work piece can be classified as “OK” and/or a good weld.

The defect determination and thus also the classification of the welded work pieces is thus carried out by combining the sensor data from multiple sensors and data about the at least one processing parameter of the laser welding process. This increases the reliability of the defect determination. The described procedure can significantly increase the basis for evaluating the quality of the weld joint and reduce the risk of incorrect classification of the welded work pieces. In particular, the risk of false rejects and escapes can be reduced.

According to preferred embodiments, the at least one processing parameter is the angle of incidence 25 of the laser beam 14 on the at least one work piece 16a, 16b, the position of the laser beam 14 within the scanning field 34 of the deflection device 26, the deflection of the laser beam 14 by the deflection device 26 from the zero position 32, the position of the at least one work piece 16a, 16b within the scanning field 34 of the deflection device 26, the position of the processing path 19 within the scanning field 34 of the deflection device 26, the adjustment speed of the deflection element of the deflection device 26, the position and/or the adjustment angle of the deflection element of the deflection device 26. Furthermore, according to embodiments, the sensor data of the at least two sensors comprise the first to third intensity data of the first to third intensity sensors of the sensor unit 44, wherein the first to third intensity data comprise measurement values of the radiation intensity of the process radiation during the laser welding process.

As previously described with reference to FIGS. 1 and 2, the position of the at least one deflection element of the deflection device 26 or the angle of incidence 25 of the laser beam 14 on the at least one work piece 16a, 16b can influence a signal level of the sensor data output by the corresponding sensors, in particular the first to third intensity data.

Furthermore, the focusing optics 24, in particular in the case of an F-theta lens, can have an influence on the signal levels. The focusing optics 24 is usually optimised only for the wavelength of the laser beam 14. The focusing optics 24 can therefore cause chromatic aberration for radiation with a different wavelength than the wavelength of the laser beam 14. This effect is amplified by a large displacement of the laser beam 14 from the zero position 32 by the deflection device 26.

By including and taking into account at least one of the aforementioned processing parameters in the defect determination, the influences of the focusing optics 24 and the deflection device 26 on the sensor data can be taken into account in the defect determination. In this way, it can be avoided that variable or changing signal levels of the sensor data, resulting for example from different positions in the scanning field, lead to an unreliable defect determination. The signal level can indicate an average signal standard of the detected sensor data or the measurement values of the radiation intensity. In particular, the signal level may be defined as the time average of the measurement values of the radiation intensity.

Further processing parameters which may be included in the defect determination may comprise: an alignment of the laser welding head to the at least one work piece, a focal position of the laser beam, a focal diameter of the laser beam, a focal shape of the laser beam, a processing speed, a processing direction, a material and/or a thickness of the at least one work piece.

With reference to FIG. 1, the alignment of the laser welding head 14 with respect to the at least one work piece 16a, 16b, the processing speed, the processing direction, the material, the thickness of the at least one work piece 16a, 16b can be transmitted from the control unit (not shown) of the laser welding head 12, for example the control unit of the deflection device 26 (not shown) and/or from the higher-level control unit (not shown) of the laser welding system 10 to the control unit 48. The focal position of the laser beam 14, the focal diameter of the laser beam 14 and the focal shape of the laser beam 14 can be transmitted from the collimating optics 22 or the control unit of the laser welding head 12 to the control unit 48.

By taking into account the material, in particular the material properties, or the thickness of the at least one work piece, it can be ensured in particular that the defect determination can be reliably performed even after a batch change of the work pieces. The material properties include the surface quality. This is described, among other things, by the reflection and coupling-in behaviour of the material for the laser beam. Thus, a different surface quality can have an influence on the batch change of work pieces when the reflection and coupling-in behaviour differ between two batches. The focal position, the focal diameter, the focal shape, the material and the thickness of at least one work piece and the processing speed also have an influence on the radiation intensity of the process radiation emitted during the laser welding process. If these processing parameters are taken into account in the defect determination, the defect determination can be performed more reliably.

The correlated signals can also serve as input parameters for a laser welding process control. In the event that the defect determination is performed during the laser welding process, the laser welding process can be controlled based on the result of the defect determination by adjusting or setting at least one processing parameter, in particular the processing speed, the laser power and/or the focal position of the laser beam. For example, when it has been determined that the weld joint already formed does not establish an electrical or mechanical connection between the work pieces, or establishes an insufficient connection, the laser power can be increased and/or the processing speed can be decreased during the laser welding process.

With reference to FIG. 1, the control can be performed by the control unit 48 or by the higher-level control unit of the laser welding system 10.

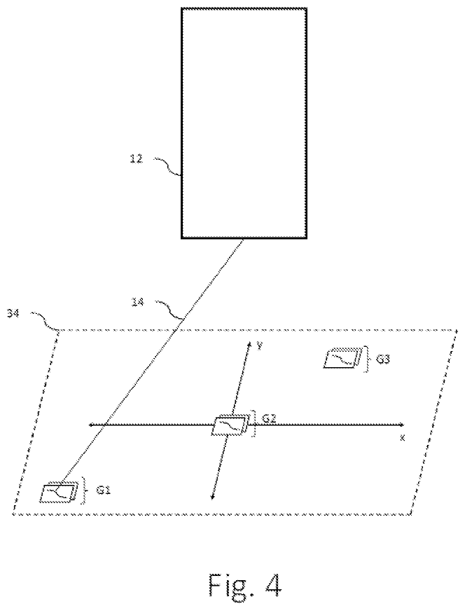

Based on the result of the defect determination, a subsequent laser welding process can also be controlled. FIG. 4 shows a schematic view of multiple work piece groups in a scanning field of a deflection device of a laser welding system according to embodiments for illustrating a method according to embodiments of the present disclosure. FIG. 4 illustrates how the method for monitoring laser welding processes is carried out on multiple work piece groups.

Three similar work piece groups G1, G2, G3 are successively welded by the same laser welding process according to embodiments of the present disclosure. For each laser welding process, i.e. for each of the three work piece groups G1-G3, the method for monitoring the laser welding process according to FIG. 3 is performed. As shown, each of the work piece groups G1-G3 comprises two work pieces to be welded, but the present disclosure is not limited thereto.

Each of the three work piece groups G1-G3 is located at a different position in the scanning field 34 of the deflection device 26 of the laser welding system 10 according to FIG. 1. Thus, the processing path to be traversed in each case for forming the weld is also located at a different position in the scanning field 34 of the deflection device 26. The three work piece groups G1-G3 comprise similar work pieces and the same laser welding process is to be performed for each of the work piece groups G1-G3.

As can be seen, with a stationary arrangement of the laser welding head 12 during welding of the three work piece groups G-1G3, the displacement of the laser beam 14 is dependent on the position of the respective group of work pieces G1-G3 in the scanning field 34 and thus on the position of the respective processing path in the scanning field 34. Accordingly, the angle of incidence of the laser beam 14 and thus a portion of the process radiation coupled into the laser welding head 12 differs between the work piece groups G1-G3. For example, a smaller portion of the process radiation is coupled into the laser welding head 12 for the work piece groups G1 and G3 than for the work piece group G2, since the angle of incidence is greater for the work piece groups G1 and G3 than for the work piece group G2. This in turn causes the signal levels of the first to third intensity data in particular to vary between the work piece groups G1-G3.

According to embodiments, the position of the respective work piece group G1-G3, the position of the respective processing path for the work piece groups G1-G3, the angle of incidence of the laser beam 14, the displacement of the laser beam 14 from the zero position and/or the position of the laser beam 14 in the scanning field 34 of the deflection device 34 are taken into account when determining whether the weld joint formed by the respective laser welding process has a defect. This can ensure that the varying signal levels of the sensor data do not result in unreliable defect determination. The position of a processing path within the scanning field 34 may be defined as the position of the centre of the processing path in the scanning field.

Further, according to embodiments, the laser welding process on the work piece groups G1-G3 is controlled based on the defect determination for a previous laser welding process. For example, when it has been determined for the first welded work piece group G1 that the weld joint has a defect, the laser welding process for welding work piece groups G2 and/or G3 can be controlled accordingly. For example, the laser power, the focal position of the laser beam 14 and/or the processing speed can be adjusted.

The present disclosure relates to a system for material processing by means of a laser beam, in particular a laser welding system, which comprises a so-called laser welding head and a sensor system, preferably a laser welding head with integrated sensor system. The signals of the sensors of the sensor system are combined and evaluated in such a way that not only the signals of the individual sensors but also a correlation of the signals from multiple sensors can be utilized to evaluate the quality of the welding or the welding process. In this way, defects can be detected reliably and automatically with a minimum of false rejects or with a minimum escape rate. Furthermore, information from the laser welding head, in particular a scanner unit, (e.g. position, speed) can also be included in this correlation evaluation. The sensor system comprises, for example, at least two of the following sensors: photodiodes for evaluating the process light, the melt pool dynamics and the back reflection, photodiodes for determining the currently used laser power, an optical coherence tomography, and a visual image recording and image processing (camera). The sensor system can be con-nected to the laser welding head. This type of procedure allows the signals to be displayed in real time, conveniently merged with the results of the welds and correlated with each other, wherein the correlation can be established, for example, by using neural networks or other suitable methods, e.g. from the field of artificial intelligence. In addition, the detection and correlation of sensor data from multiple sensors can also provide insights and information regarding the necessary maintenance of the laser welding system.

1. A method for monitoring a laser welding process, the method comprising the steps of:
performing the laser welding process by a laser welding head which irradiates a laser beam onto at least one work piece for forming a weld joint, wherein the laser beam is guided along a processing path by a deflection device,
detecting a radiation emanating from the work piece and coupled into the laser welding head as sensor data by at least two sensors during the laser welding process, wherein the radiation runs at least partially superimposed with the laser beam and is decoupled from the beam path of the laser beam after passing the deflection device in order to impinge on the at least two sensors; and
determining whether the weld joint has a defect based on the detected sensor data and at least one processing parameter of the laser welding process.

2. The method according to claim 1, further comprising the step of:
classifying the welded work piece as a reject when it is determined that the weld joint has a defect.

3. The method according to claim 1, wherein the processing parameter comprises at least one of the following parameters: an alignment of a laser welding head irridiating the laser beam to the at least one work piece, an angle of incidence of the laser beam on the at least one work piece, a focal position of the laser beam, a focal diameter of the laser beam, a focal shape of the laser beam, a processing speed, a processing direction, a velocity vector of the laser beam along the processing path, a material and/or a thickness of the at least one work piece, and at least one parameter of the deflection device, in particular a position of the laser beam within a scanning field of the deflection device, a displacement of the laser beam by the deflection device from a zero position, the position of the processing path within the scanning field of the deflection device, an adjustment speed of a deflection element of the deflection device, and/or an adjustment angle of a deflection element of the deflection device.

4. The method according to claim 1, wherein the at least two sensors comprise at least two of the following sensors:
a first intensity sensor, preferably comprising a photodiode, wherein the first intensity sensor is arranged to detect first intensity data of a radiation intensity of a process radiation emitted during the laser welding process in a visible wavelength range;
a second intensity sensor, preferably comprising a photodiode, wherein the second intensity sensor is arranged to detect second intensity data of a radiation intensity of the process radiation in an infrared wavelength range;
a third intensity sensor, preferably comprising a photodiode, wherein the third intensity sensor is arranged to detect third intensity data of a radiation intensity of a laser beam reflected back from a surface of the at least one work piece;
a fourth intensity sensor preferably comprising a photodiode, wherein the fourth intensity sensor is arranged to detect fourth intensity data of a radiation intensity of the laser beam for detecting an irradiated laser power;
an image sensor preferably comprising a camera, wherein the image sensor is arranged to detect image data by taking an image of a surface of the at least one work piece; and
a distance sensor preferably comprising an optical coherence tomograph, wherein the distance sensor is arranged to detect distance data of a distance to the at least one work piece and/or arranged to detect distance data of a depth of a vapour capillary generated during the laser welding process and/or arranged to detect surface profile data of a surface of a weld formed by the laser welding process.

5. The method according to any of the preceding claim 1, wherein detecting sensor data comprises at least two of the following:
detecting first intensity data of a radiation intensity of a process radiation emitted during the laser welding process in a visible wavelength range,
detecting second intensity data of a radiation intensity of a process radiation emitted during the laser welding process in an infrared wavelength range,
detecting third intensity data of a radiation intensity of a laser beam reflected back from the at least one work piece,
detecting fourth intensity data for determining a laser power reflected back,
detecting image data by taking an image of a surface of the at least one work piece, and
detecting distance data of a distance of a laser welding head irridiating the laser beam from the at least one work piece and/or a depth of a vapour capillary generated during the laser welding process and/or surface profile data of a surface of a weld formed by the laser welding process.

6. The method according to claim 1, wherein determining whether a defect of the weld joint is present is performed during performing the laser welding process in real time and/or after performing the laser welding process.

7. The method according to claim 1, wherein it is determined whether the weld joint has any of the following defects: a missing or insufficient electrical and/or physical connection through the weld joint and/or a gap between welded work pieces.

8. The method according to claim 1, wherein determining whether the weld joint has a defect is performed by means of algorithms and/or by means of a machine learning method, in particular using an artificial neural network.

9. The method according to claim 1, wherein determining whether the weld joint has a defect comprises:
separately evaluating the sensor data for each of the at least two sensors,
combining the evaluations by a logic operation, and
determining whether the weld joint has a defect based on the combined evaluation.

10. The method according to claim 1, further comprising:
controlling the laser welding process when it has been determined that there is a defect of the weld joint by adjusting at least one processing parameter.

11. The method according to claim 1, further comprising:
preprocessing, in particular by means of an FPGA, the sensor data of the at least two sensors.

12. The method according to claim 1, wherein the deflection device has a maximum deflection angle greater than 10 degrees, in particular 20 degrees, and/or wherein the deflection device has a scanning field whose length and/or width is equal to or greater than 50 mm.

13. A laser welding system comprising:
a laser welding head for irridiating a laser beam onto at least one work piece to form a weld joint, wherein the laser welding head comprises a deflection device for guiding the laser beam along a processing path,
at least two sensors, wherein each of the sensors is arranged to detect radiation emanating from the work piece and coupled into the laser welding head as sensor data during the laser welding process, and
a control unit arranged to perform a method according to claim 1.

14. The laser welding system according to claim 13, wherein the control unit is arranged to control the laser welding process, in particular by adjusting the laser power and/or the focal position of the laser beam, based on the determination whether the weld joint has a defect.

15. The laser welding system according to claim 13, wherein the laser welding head comprises at least one of the following elements:
a first coupling-in device for coupling the laser beam into the deflection device and for coupling out the radiation emanating from the work piece from a beam path of the laser beam, wherein the first coupling-in device is arranged upstream of the deflection device in the propagation direction of the irradiated laser beam;
a second coupling-in device for splitting the radiation coupled out of the beam path of the laser beam in order to direct a part of the radiation to a first one of the at least two sensors and another part of the radiation to a second one of the at least two sensors;
collimating optics for adjusting the focal position of the laser beam, and
an F-theta lens for focusing the laser beam on the at least one work piece.
